(19) United States
(12) Patent Application Publication
(10) Pub. No.: US 2014/0157012 A1
(43) Pub. Date: Jun. 5, 2014

(54) INFORMATION PROCESSING APPARATUS AND POWER SUPPLYING METHOD

(71) Applicant: KABUSHIKI KAISHA TOSHIBA, Tokyo (JP)

(72) Inventors: Katsuhiro Uchida, Ome-shi (JP); Wataru Nakanishi, Hamura-shi (JP)

(73) Assignee: KABUSHIKI KAISHA TOSHIBA, Tokyo (JP)

(21) Appl. No.: 14/031,953

(22) Filed: Sep. 19, 2013

(30) Foreign Application Priority Data
Nov. 30, 2012 (JP) 2012-262864

(51) Int. Cl. G06F 1/26

(52) U.S. Cl. CPC G06F 1/266
USPC 713/300

(57) ABSTRACT

According to one embodiment, an information processing apparatus including a power source configured to supply power to an external device, including: a detector configured to detect a type of the external device; and a power supply configured to temporarily shut off supply of power to the external device from a first power supply mode and to supply power from a second power supply mode, when the detected type of the external device satisfies a first condition.

### CROSS REFERENCE TO RELATED APPLICATION(S)

The application is based upon and claims the benefit of priority from Japanese Patent Application No. 2012-262864 filed on Nov. 30, 2012, the entire contents of which are incorporated herein by reference.

### BACKGROUND

1. Field

The present invention relates to an information processing apparatus and a power supplying method which control USB charging and a wakeup function.

2. Description of the Related Art

Recent information processing apparatus such as PCs (personal computers) are equipped with interfaces for connection to various devices. Among those interfaces are bus interfaces that comply with such standards as USB (universal serial bus; registered trademark (this notification will be omitted below)) and IEEE 1394 through which power can be supplied to devices from the information processing apparatus.

For example, Patent document 1 discloses a technique for starting supply of power to a device upon its insertion into a bus interface of an information processing apparatus even if the information processing apparatus is in a power-off state or a power saving state.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a block diagram showing the configuration of a computer according to a first embodiment;

FIG. 2 is a block diagram illustrating a USB charging function according to the first embodiment;

FIG. 3 is a flowchart of a control with wakeup device detection according to the first embodiment;

FIG. 4 illustrates how “information” used in the first embodiment is transferred;

FIG. 5 is a flowchart showing a control with detection of a USB bus state according to a second embodiment;

FIGS. 6A and 6B illustrate an IIC interface used in the second embodiment;

FIG. 7 is a flowchart showing a control with Vbus current detection according to a third embodiment; and

FIGS. 8A and 8B show a USB pin arrangement.

### DETAILED DESCRIPTION

According to one embodiment, an information processing apparatus including a power source configured to supply power to an external device, including: a detector configured to detect a type of the external device; and a power supply configured to temporarily shut off supply of power to the external device from a first power supply mode and to supply power from a second power supply mode, when the detected type of the external device satisfies a first condition.

Information processing apparatus according to embodiments of the present invention will be hereinafter described in detail with reference to the accompanying drawings.

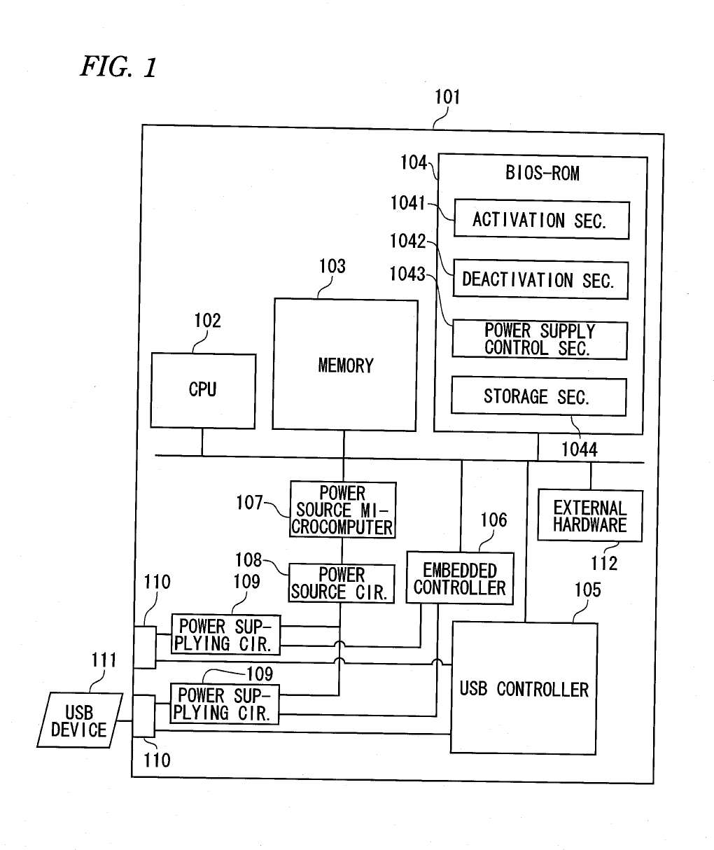

FIG. 1 is a block diagram showing the configuration of a computer 101 according to a first embodiment. As shown in FIG. 1, the computer 101 includes a CPU 102, a memory 103, a BIOS-ROM 104, a USB (universal serial bus) controller 105, an embedded controller (EC) 106, a power source microcomputer 107, a power source circuit 108, power supplying circuits 109, USB ports 110, and external hardware 112. Although the following description will be directed to a case that the device that is supplied with power from the computer 101 is a USB device 111, it may be a device that complies with a standard other than USB, such as IEEE 1394.

The CPU 102 is a processor which controls the operation of the computer 101. The CPU 102 loads a system BIOS (basic input/output system) into the memory 103 from the BIOS-ROM 104 and controls various kinds of hardware according to it. The CPU 102 also loads an OS (operating system) into the memory 103 from a hard disk (not shown) or the like and runs it. Furthermore, the CPU 102 also runs programs other than the system BIOS and OS, such as various application programs.

The memory 103 is a main storage memory in which the system-BIOS stored in the BIOS-ROM 104, the OS stored in the hard disk or the like, and an application program is to be developed for execution.

The BIOS-ROM 104 is a memory for storing the system BIOS for making various kinds of settings mainly for hardware. In terms of functions, the system BIOS stored in the BIOS-ROM 104 includes an activation section 1041, a deactivation section 1042, a power supply control section 1043, and a storage section 1044.

The activation section 1041 performs processing of activating various kinds of hardware provided inside the computer 101 according to an instruction from the power source microcomputer 107 or the power supply control section 1043 (described later). Where the activation section 1041 performs activation processing according to an instruction from the power supply control section 1043, the activation section 1041 can also make a transition from a state that the USB controller 105 and a power supplying circuit 109 are supplied with power though the computer 101 itself is not in operation to a state that the computer 101 is in operation.

More specifically, when receiving an instruction to perform activation processing from outside, the activation section 1041 judges whether the instruction is from the power source microcomputer 107 or the power supply control section 1043. If judging that the instruction is from the power supply control section 1043, the activation section 1041 then judges whether a setting that permits USB power supply to a USB port 110 is made or not. As described later, the case that an instruction to perform activation processing is from the power supply control section 1043 means a case that a USB wakeup setting is made.

The USB wakeup setting is a setting that enables USB power supply when a USB device 111 is inserted into a USB port 110 in a state that the USB controller 105 and the power supplying circuit 109 are supplied with power though the computer 101 itself is not in operation.

For example, a setting as to whether to permit USB power supply can be made using such a tool as a utility that is installed in the computer 101 and serves to make a USB power supply setting. For example, it is possible to make a USB power supply permission/prohibition setting through a pull-down menu that is displayed on a display device (not shown) by a utility. As described later, a USB power supply permission/prohibition setting is stored in the storage section 1044 for each USB port 110.

If judging that the instruction to perform activation processing is from the power supply control section 1043 and a setting that permits USB power supply to the USB port 110 concerned is made, the activation section 1041 informs the power supply control section 1043 of these facts.

On the other hand, if judging that the instruction to perform activation processing is not from the power supply control section 1043 (i.e., it is from the power source microcomputer 107) or a setting that permits USB power supply to the USB port 110 concerned is not made though the instruction is from the power supply control section 1043, the activation section 1041 performs processing of initializing various kinds of hardware provided inside the computer 101.

For example, the activation section 1041 performs processing of initializing the settings of a VGA (video graphic array) and IDE (integrated device electronics). After performing this processing, the activation section 1041 activates the OS and establishes a state that a user can use the computer 101.

Next, the deactivation section 1042 will be described. The deactivation section 1042 is a section which performs processing of deactivating various kinds of hardware of the computer 101 according to an instruction from the OS or an application and thereby makes a transition from a state that the computer 101 is in operation to a state that the USB controller 105 and a power supplying circuit 109 are supplied with power though the computer 101 itself is not in operation. Naturally, in a certain case, the deactivation section 1042 renders the computer 101 in a complete non-operation state.

More specifically, if the OS etc. are shut down, the deactivation section 1042 performs processing of saving VGA and IDE settings and other processing. Then, the deactivation section 1042 judges whether a setting that permits USB power supply to a USB port 110 is made or not. As mentioned above, whether USB power supply to each USB port 110 is permitted or not is set by the utility and the setting is stored in the storage section 1044.

If judging that a setting that permits USB power supply to a USB port 110 is made, the deactivation section 1042 then judges whether or not the USB controller 105 has detected a signal indicating insertion of a USB device 111 into the USB port 110.

Next, the power supply control section 1043 will be described. The power supply control section 1043 is a section which determines a power supply mode for doing effective USB power supply to a USB device 111 and makes various settings for USB power supply such as a USB wakeup setting.

Each power supply mode is defined by a combination of conditions of various components of the computer 101 such as the USB controller 105, the power source circuit 108, and the external hardware 112 for switching a USB device 111 to a charging mode . For example, a power supply mode is defined by a combination of states (on/off or H (high)/L (low)) of control signals for various components of the computer 101 such as the USB controller 105, the power source circuit 108, and the external hardware 112. Such settings of each power supply mode are stored in the storage section 1044.

The power supply modes for USB power supply include CDP (first power supply mode; described below) and SDP (second power supply mode; described later) and also include DCP (dedicated charging port) etc. DCP is not categorized as an operation mode with information exchange with the device side, and enables power supply without making a communication with the device side.

As for the USB charging function which realizes charging of a device utilizing the USB interface, a mode called CDP (charging downstream port) is prescribed in the USB Battery Charging Specification. This is a mode which is established in an S0 (system on) state, and which enables an ordinary USB communication while charging is performed at a maximum of 1.5 A. CDP is recognized by hardware handshaking through data line manipulations and monitoring. As for a current consumption, a negotiation is done after enumeration (described later).

That is, CDP is a definition of a newer, large-current USB port for PCs, lap-top computers, and other kinds of hardware. CDP enables supply of a maximum of 1.5 A, and a device that is plugged into an apparatus being in the CDP mode can recognize CDP by hardware handshaking through D+/D− line manipulations and monitoring.

There is a problem that relates to the relationship between the following two kinds of operation states:

(1) CDP enable in an S0 state/CDP disable in S3 (sleep), S4 (hibernation) , and S5 (system off) states

(2) USB wakeup enable

If higher priority is given to the operation state (1), when a transition is made from S0 to S3 or S4, it is necessary to instantaneously suspend (on-off-on) the power supply to the Vbus line (described below) of the USB charging port (hereinafter referred to as “Vbus toggling”). As a result, wakeup of the USB charging port is disabled.

Conversely, if higher priority is given to the operation state (2), the USB charging port should not be Vbus-toggled when a transition is made from S0 to S3 or S4. As a result, the CDP mode is enabled even in the S3 or S4 state, resulting in increase in power consumption.

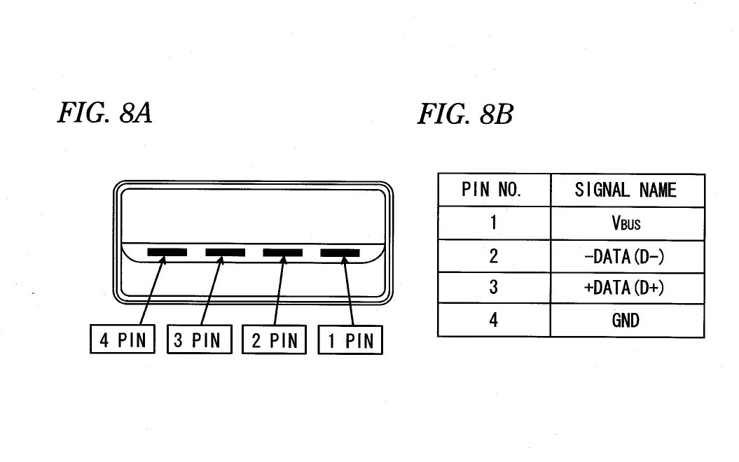

How Vbus of USB is supplied will be outlined below. First, basically, data transfer is performed by a single master method; that is, data are exchanged after a call from the host side. A cable can be constructed by two signal liens and two power lines. More specifically, as found in USB connectors, they are two 3.3-V differential signal lines (D+ and D−) and two power lines (Vbus (5 V) and GND) . FIGS. 8A and 8B show a USB pin arrangement; FIG. 8A shows a schematic external form of a plug called a “standard A plug” and FIG. 8B shows its pin arrangement.

This embodiment is directed to a method for allowing wakeup through a USB charging port to function properly even at the time of a transition from S0: CDP enable to Sx: CDP disable (x: a number other than 0).

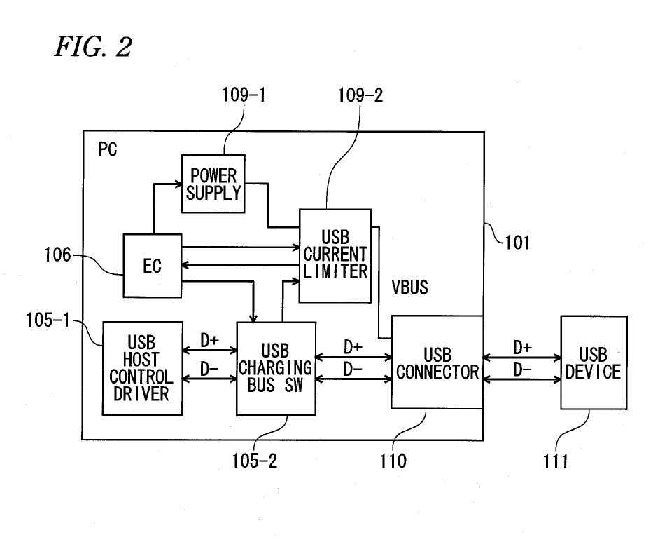

FIG. 2 is a block diagram illustrating a USB charging function according to the embodiment. A USB host control driver 105-1 and a USB charging bus SW (switch) 105-2 are functional blocks of the USB controller 105. A power supply 109-1 and a

USB current limiter 109-2 are functional blocks of each power supplying circuit 109.

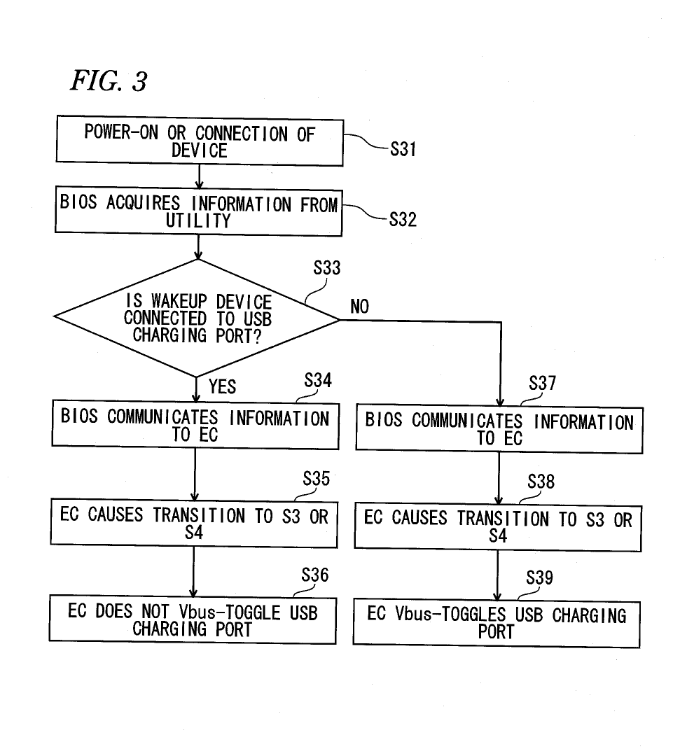

A control with wakeup device detection according to the embodiment will be described below using a flowchart of FIG. 3. The term “wakeup device” means, for example, a keyboard or a mouse that is USB-connected to the computer 101. In the case of a keyboard, the main body of the computer 101 is booted when a user pushes any of its keys.

Important points will be described first. The USB host control driver 105-1 has recognized to what USB ports wakeup devices are connected. A utility capable of informing the BIOS of information received from the USB host control driver 105-1 is provided in the OS.

When a transition is made from S0 to S3 or S4, the BIOS communicates, to the EC 106, information received from the above utility. In response, the EC 106 operates as follows:

(A) If a wakeup-compatible device is connected to a USB charging port, the EC 106 does not perform Vbus toggling (described above) on the USB charging port when a transition is made to S3 or S4.

(B) If a wakeup-compatible device is not connected to a USB charging port, the EC 106 performs Vbus toggling on the USB charging port when a transition is made to S3 or S4.

More specifically, at step S31, the computer 101 is powered on or a device is USB-connected to it. At step S32, the BIOS acquires information from the utility. At step S33, the BIOS judges whether or not a wakeup device is connected to a USB charging port. If the judgment result is affirmative, the process moves to the next step S34. If the judgment result is negative, the process jumps to step S37.

At step S34, the BIOS communicates information to the EC 106. At step S35, the EC 106 causes a transition to S3 or S4. At step S36, the EC 106 finishes the process without Vbus-toggling the USB charging port (to allow wakeup through the USB charging port to function properly with a restriction that a transition from CDP to SDP is prohibited).

At step S37, the BIOS communicates information to the EC 106. At step S38, the EC 106 causes a transition to S3 or S4. At step S39, the EC 106 finishes the process after Vbus-toggling the USB charging port (to permit a transition from CDP to SDP).

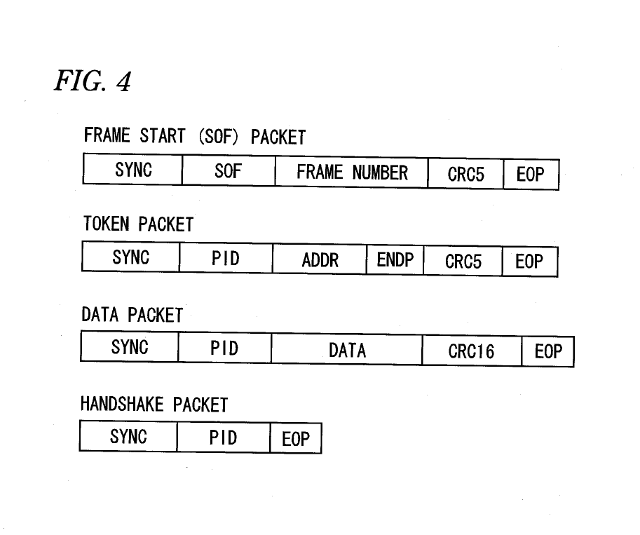

FIG. 4 supplements a general method for transmitting the above-described “information” used in the embodiment. A host is provided in the main body of a personal computer. A maximum of 127 functions can be connected to one host. Each function is provided in a peripheral device which is a USB device. For each of main purposes, a protocol is defined as a class.

In USB, four kinds of transfer methods are available one of which can be used for each purpose selectively: control transfer, bulk transfer, interrupt transfer, and isochronous transfer. Among these kinds of transfer methods, the control transfer is used for transfer of the above-described “information.” The control transfer is transfer method which is used for configuration (setting of parameters) and transmission or reception of a message.

The host performs communicates with each USB device by designating an address and an end point number which are assigned to it. First, as enumeration (a first data exchange performed between a device and the host to determine a device type), the host identifies a USB device connected to the bus, gives an address to it, and fixes collected descriptor information. The USB device reports its attributes to the host using descriptors. There are several kinds of descriptors. The USB device returns each piece of descriptor information relating to itself which is requested by the host. The USB device becomes usable as soon as the host assigns an address to it and recognizes its device configuration.

Transfers are performed at intervals of 1 ms on a frame-by-frame basis, and each device is given a short transfer time in each frame. The host starts each frame by transmitting an SOF packet every 1 ms or 125 μs. Then, the host informs a device (s) of a transfer type, a device address, and an end point by transmitting a token packet to it. Only an address-specified device (s) responds using a data packet or a handshake packet.

FIG. 4 shows structures of respective packet types. “Information” can be contained in a data portion (0th to 1, 023rd bits) of a data packet.

A second embodiment of the invention will be described with reference to FIGS. 2, 5, and 6. Descriptions of items having the same ones in the first embodiment will be omitted.

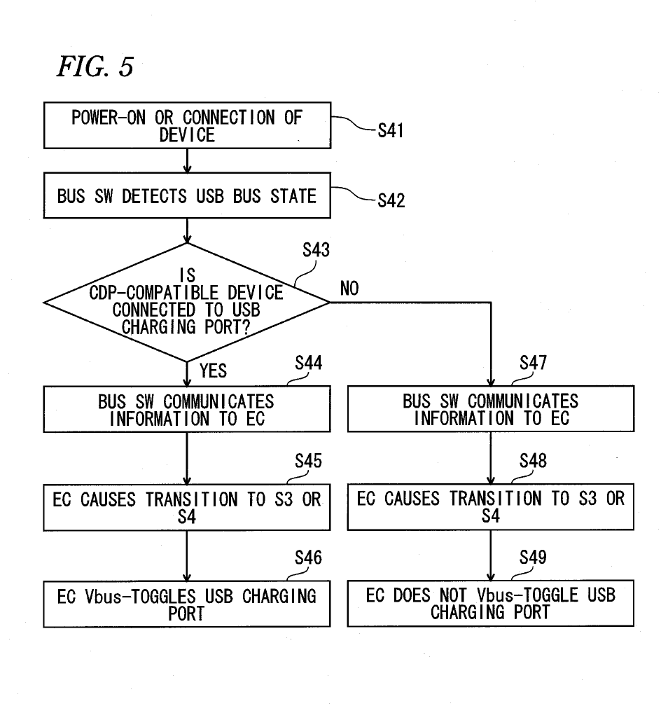

A control with detection of a USB bus state according to the second embodiment will be described with reference to a flowchart of FIG. 5.

Important points will be described first. In the CDP mode, the USB charging bus SW 105-2 detects how a bus signal coming from the device connected to the USB port behaves. By detecting behavior of the bus signal, the USB charging bus SW 105-2 whether the device-side operation mode is a CDP mode operation or an SDP (standard downstream port) mode operation. The USB charging bus SW 105-2 informs the EC 106 of a judgment result using a flag or an interface such as an I²C (IIC; described later in detail). The host side recognizes a fact that the device-side operation mode is an SDP mode operation by detecting data line pull-down.

Definitions of power sources for charging are added to the Battery Charging Specification in the form of an extension of the power supply that is prescribed in USB 2.0. Three kinds of power sources including CDP and SDP are defined there.

SDP is a port that is similar to the one defined in USB 2.0, and is of the same type as ports commonly used in desk-top computers and lap-top computers. The maximum load current is 2.5 mA in a suspended state and is 100 mA in a connected, unsuspended state. The maximum load current is 500 mA when such a setting is made. A device can recognize SDP by hardware by detecting that each of the USB data lines (D+ and D−) is connected to the ground individually. Even in this case, to comply with the USB standard, it is necessary to perform enumeration.

The EC 106 as follows according to information received from the USB charging bus SW (hereinafter abbreviated as a bus SW) 105-2:

(A) If the device-side operation mode is a CDP mode operation, the EC 106 performs Vbus toggling on the USB charging port when a transition is made to S3 or S4.

(B) If the device-side operation mode is an SDP mode operation, the EC 106 does not perform Vbus toggling on the USB charging port when a transition is made to S3 or S4.

More specifically, at step S41, the computer 101 is powered on or a device is USB-connected to it. At step S42, the bus SW 105-2 detects a USB bus state. At step S43, the bus SW 105-2 judges whether or not a CDP-compatible device is connected to a USB charging port. If the judgment result is affirmative, the process moves to the next step S44. If the judgment result is negative, the process jumps to step S47.

At step S44, the bus SW105-2 communicates information to the EC 106. At step S45, the EC 106 causes a transition to S3 or S4. At step S46, the EC 106 finishes the process after Vbus-toggling the USB charging port (because wakeup does not function).

At step S47, the bus SW 105-2 communicates information to the EC 106. At step S48, the EC 106 causes a transition to S3 or S4. At step S49, the EC 106 finishes the process without Vbus-toggling the USB charging port (to allow wakeup through the USB charging port to function properly).

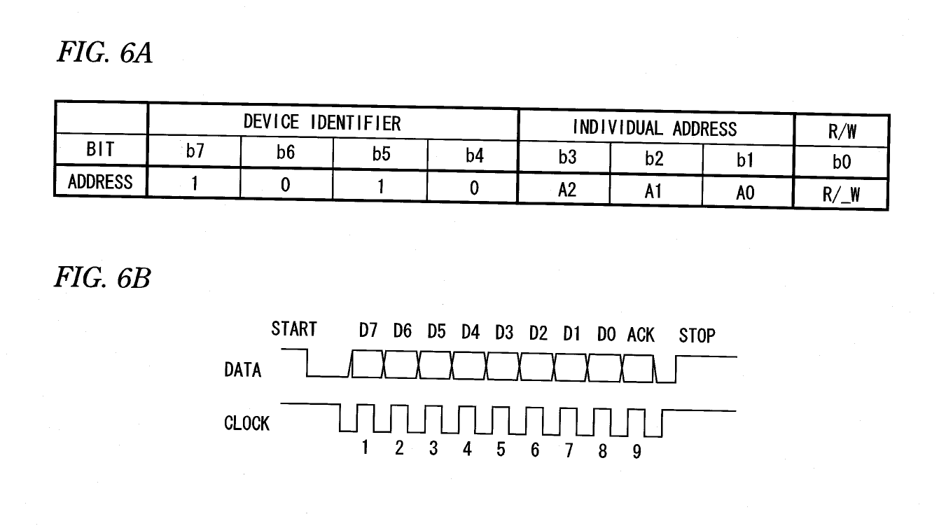

FIGS. 6A and 6B illustrate the above-mentioned IIC interface. An IIC interface bus (IIC-BUS) consists of two signal lines, that is, a clock line for a pulled-up clock that is output from a master device and a data line for bidirectional communication between the master device and a slave device.

FIG. 6A shows an example structure of a slave address. The slave address has an 8-bit length and its upper four bits are fixed depending on the device type. Its LSB unit writing if it is equal to “0,” and unit reading if is equal to “1.” Therefore, actually, usable bits of the slave address are the first to third bits.

FIG. 6B is a schematic timing chart of the two communication lines. A data transfer is started when the signal level of the data line has become low (see the upper part of the chart). Data is transmitted in order stating from the MSB. The data transfer is stopped when the signal level of the data line has become high. Corresponding clock timing is shown in the bottom part of the chart. The example of FIG. 6B is of a transfer of 1-byte data. If a set of data and ACK is transferred plural times until establishment of a stop state, substantial information can be communicated using the second and following bytes though the first byte is used for transfer of a slave address.

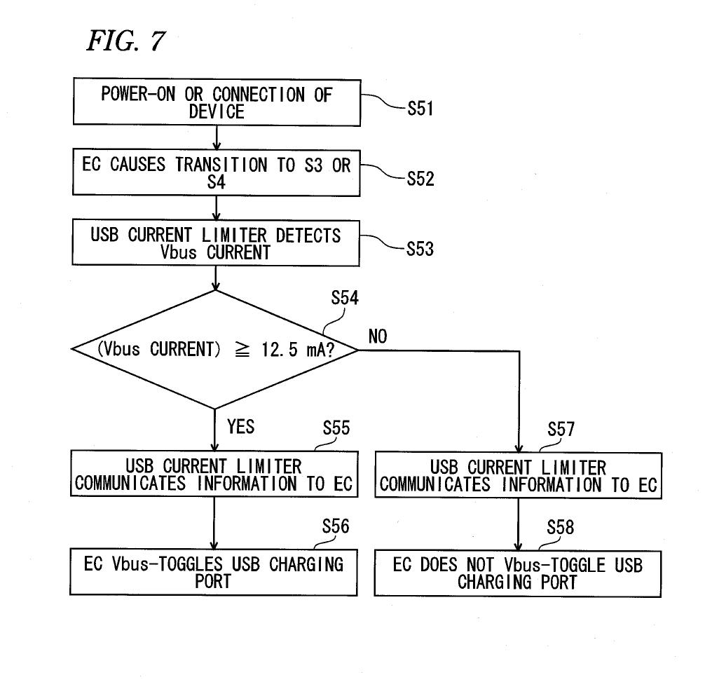

A third embodiment of the invention will be described with reference to FIGS. 2 and 7. Descriptions of items having the same ones in the first and embodiments will be omitted.

A control with Vbus current detection according to the third embodiment will be described with reference to a flowchart of FIG. 7.

Important points will be described first. The USB current limiter 109-2 has a function of detecting a load current value of a device. After a transition from S0 to S3 or S4, the

USB current limiter 109-2 informs the EC 106 whether or not the load current value is larger than or equal to 12.5 mA using a flag or an interface such as an I²C.

(A) If the load current value is larger than or equal to 12.5 mA, the EC 106 performs Vbus toggling on the USB charging port after a transition to S3 or S4.

(B) If the load current value is smaller than 12.5 mA, the EC 106 does not perform Vbus toggling on the USB charging port after a transition to S3 or S4.

More specifically, at step S51, the computer 101 is powered on or a device is USB-connected to it. At step S52, the EC 106 causes a transfer to S3 or S4. At step S53, the USB current limiter 109-2 detects a Vbus current. At step S54, the USB current limiter 109-2 judges whether or not the Vbus current is larger than or equal to 12.5 mA. If the judgment result is affirmative, the process moves to the next step S55. If the judgment result is negative, the process jumps to step S57.

At step S55, the USB current limiter 109-2 communicates information to the EC 106. At step S56, the EC 106 finishes the process after Vbus-toggling the USB charging port (because wakeup does not function).

At step S57, the USB current limiter 109-2 communicates information to the EC 106. At step S58, the EC 106 finishes the process without Vbus-toggling the USB charging port (to allow wakeup through the USB charging port to function properly).

In the above embodiments, it is intended to attain power saving of the information processing apparatus (computer 101) while it is powered off by enabling both of USB charging during power-on and wakeup during power-off. The information processing apparatus is such as to be able to supply power to an external device, and the connecting unit for connection of an external device has the USB ports 110 at one ends. The power supplying unit for supplying power to an external device connected to the connecting unit is mainly composed of the power source microcomputer 107, the power source circuit 108, and the power supplying circuits 109.

The above embodiments also have the following features:

(1) The conventional restriction that wakeup through a USB charging port does not function in the setting that permits a transition from S0: CDP enable to Sx: CDP disable is eliminated.

(2) Even in setting that permits a transition from S0: CDP enable to Sx: CDP disable, no increase in power consumption is caused and wakeup through a USB charging port functions properly. (The power supplying unit is temporarily disabled in a state that the wakeup function of an external device is unnecessary or is not given higher priority (by Vbus toggling of the power line) and power saving during power-off is attained for USB charging.)

(3) S0: CDP enable can be set as a standard setting of a system or a device, and authentication and logo request are possible in this setting.

The invention is not limited to the above embodiments and may be practiced in such a manner that constituent elements are modified in various manners without departing from the spirit and scope of the invention. And various inventive concepts may be conceived by properly combining plural constituent elements disclosed in each embodiment. For example, several ones of the constituent elements of each embodiment may be omitted. Furthermore, constituent elements of different embodiments may be combined as appropriate.

What is claimed is:

1. An information processing apparatus comprising a power source configured to supply power to an external device, comprising:
a detector configured to detect a type of the external device; and
a power supply configured to temporarily shut off supply of power to the external device from a first power supply mode and to supply power from a second power supply mode, when the detected type of the external device satisfies a first condition.

2. The information processing apparatus of claim 1, wherein
the power supply temporarily shuts off supply of power to the external device after the information processing apparatus makes a transition to a non-operation state.

3. The information processing apparatus of claim 2, wherein
the first condition is one of following three conditions, the external device is a non-wakeup device, the external device is compatible with the first supply mode, and a load current of the external device is larger than or equal to a prescribed value.

4. A power supplying method of an information processing apparatus comprising a power source configured to supply power to an external device, comprising:
detecting a type of the external device; and
supplying power to the external device after temporarily shutting off supply of power from a first power supply mode and to supply power from a second power supply mode, when the detected type of the external device satisfies a first condition.
